(19) United States
(12) Patent Application Publication
(10) Pub. No.: US 2014/0192834 A1
(43) Pub. Date: Jul. 10, 2014

(54) APPARATUS FOR CALIBRATION OF TEMPERATURE SENSORS

(71) Applicant: Ole Einar Brønlund, Siggerud (NO)

(72) Inventor: Ole Einar Brønlund, Siggerud (NO)

(21) Appl. No.: 14/004,025

(22) PCT Filed: Mar. 7, 2012
(86) PCT No.: PCT/NO2012/000024

§ 371 Date: Mar. 13, 2014

(30) Foreign Application Priority Data
Mar. 7, 2011 (EP) 11157221.0

(51) Int. Cl. G01K 15/00

(52) U.S. Cl. CPC G01K 15/005
USPC 374/1

(57) ABSTRACT

A calibration body (140) for calibration of a temperature sensor (170). The calibration body comprises a volume (142) capable of containing a calibration fluid with a predetermined temperature and an opening (160) for receiving the temperature sensor. The opening has a flexible opening wall (131) which delimits the sensor (170) from the volume and is capable of tightly engaging the sensor (170). The opening wall (131) comprises a non-elastic wear resistant region (231) facing the opening. The non-elastic wear region (231) is connected to a path compensator (232) capable of adjusting a length of the opening wall (131) with an amount corresponding to the path around the temperature sensor (170) in the non-elastic region (231). The non-elastic region (231) can comprise a reinforced sheet material and/or a coating. An apparatus comprising the calibration body (140) and a separate pressure body (120) is also disclosed.

### BACKGROUND

1. Technical field

The invention relates to a calibration body and an apparatus for calibration of temperature sensors.

2. Background Art

As components and equipment age, and also are subjected to temperature changes and mechanical strains, the critical capacity will decrease. This is called drift. When this happens, one can no longer rely on previous capacity tests, and this may result in poorer quality in development and production. Since one can not prevent drift, one must instead detect and eliminate the effect thereof by means of calibration.

As known, calibration is to compare the capacity of equipment to be calibrated with a known standard. The standards are maintained by national and international accredited calibration laboratories. To day, there are imposed aggravated demands on the industry with respect to measuring accuracy and quality assurance (ISO 9000), and there is then required calibrating equipment which satisfies the requirement of to day and complies with the new standards within temperature calibration.

The prior art traditionally includes two principal types of calibrators, namely liquid bath calibrators and dry block calibrators.

In addition to these there is the hybrid solution known from the international application PCT/NO2000/000143 by the applicant and also granted as EP 1190228 B1, disclosing the use of a cavity made of pliable intermediate partitions wherein by subjecting the defining walls to a pressure the calibrator medium is brought into tight fitting abutment against the sensor.

This hybrid solution suffers from the disadvantages of:
it is not trivial to find a wall material for the calibrator bodies that is flexible and thus enclose the thermometers optimally while also providing good thermal conductivity,
the material in the wall facing the temperature sensor to be calibrated is subject to wear and tear during use,
it is difficult to ensure uniform pressure of the calibrator bodies against the sensor to be calibrated

Several of these issues make it difficult to make the apparatus for calibration compact and portable. An objective of the present invention is to provide an apparatus for calibration of temperature sensors that overcome at least some of the above problems while retaining the benefits from prior art.

### SUMMARY OF THE INVENTION

The object is achieved according to the invention by a calibration body for calibration of at least one temperature sensor, the calibration body comprising a volume capable of containing a calibration fluid with a predetermined temperature and an opening for receiving the temperature sensor. The opening extends from a first surface of the calibration body into the volume of the body and has a flexible opening wall delimiting the sensor from the volume and capable of tightly engaging the sensor. The opening wall comprises a non-elastic wear resistant region facing the opening. The non-elastic wear region is connected to a path compensator capable of adjusting a length of the opening wall with an amount corresponding to the path around the temperature sensor in the non-elastic region.

The non-elastic region protects the wall facing the opening from mechanical loads, i.e. wear and tear, from different sensors being inserted and removed. The path compensator compensates for different path lengths depending on the number and type(s) of temperature sensors enclosed by the flexible wall.

In another aspect, the invention comprises an apparatus comprising such a calibration body further comprising a displaceable outer wall, and a pressure body capable of exerting a pressure on the displaceable outer wall.

Further embodiments are disclosed in the dependent claims.

### BRIEF DESCRIPTION OF THE DRAWINGS

The invention will be further described below in connection with exemplary embodiments which are schematically shown in the drawings, wherein:

FIG. 1A shows a longitudinal section of a first embodiment of the apparatus according to the invention in a first state, along the line 1A-1A in FIG. 1B;

FIG. 1B shows a cross-section along the line 1B-1B in FIG. 1A;

FIG. 2 shows a cross-section of a second embodiment of an apparatus according to the invention in a first state;

FIG. 3 is a schematic drawing showing a calibrator body which is connected to a circulation system having a regulating circuit for regulating the temperature of the heat-transferring medium.

FIG. 4 shows an exploded view of the second embodiment of an apparatus according to the invention in a first state.

FIG. 5a is a side view of an inner wall 150 of the calibration body.

FIGS. 5b and c illustrate alternative path compensators.

FIGS. 6a and b show details of a circulation system within the calibration body.

### DETAILED DESCRIPTION

In the following disclosure, the term pliable relates to a property of a material wherein the material can be bent or reshaped but maintains substantially the same dimensions along its surface. An example of this is fibre reinforced sheets. Similarly the term elastic relates to a property of a material wherein the material can be bent, reshaped and also stretched and/or compressed, modifying the dimensions along its surface. An example of this is rubber. The term ‘flexible material’ means a material that is elastic or pliable or both. An example is the inner wall facing the temperature sensors, which is part elastic and part pliable: This wall should engage the temperature sensor as close as possible, yet being durable and resistant to wear and tear as discussed below.

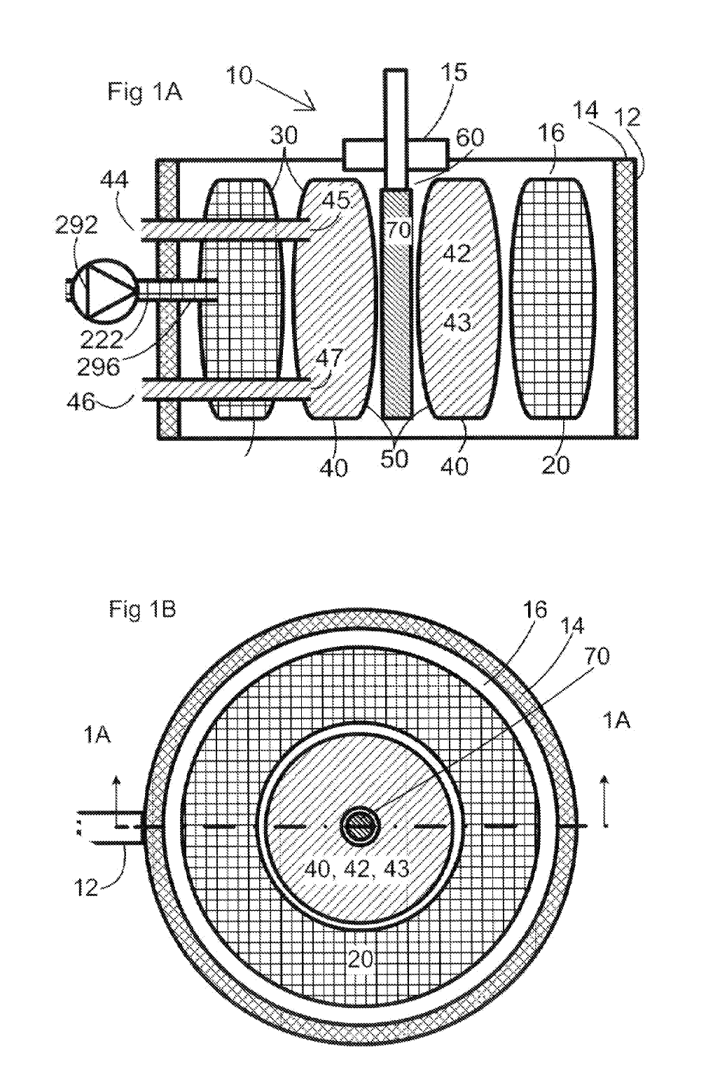

The embodiment of the apparatus according to the invention shown in FIG. 1A and 1B comprises a circularly cylindrical container constituting a jacket 12 of a suitable, for example metallic material. The jacket defines a cavity 16 in which a pressure body 20 is placed. Said pressure body defines a cavity in which there is placed a thin-walled calibrator body 40. The calibrator body 40 defines a volume 42 receiving the relevant heat-transferring medium or calibration fluid 43 which may be a liquid or a gas. The pressure body 20 is also provided with means for producing an overpressure, and possibly also an underpressure, on the calibrator body 40.

The calibrator body 40 has an outer wall defined by a first membrane 30, and an inner wall defined by a second membrane 50 thus defining a central opening 60 extending along the longitudinal axis of the jacket 12 and being adapted to receive a temperature sensor 70 to be calibrated. At the upper side of the calibrator body 40, where the opening 60 debouches and the temperature sensor 70 is to be introduced, there is applied an elastic, heat-insulating material 15.

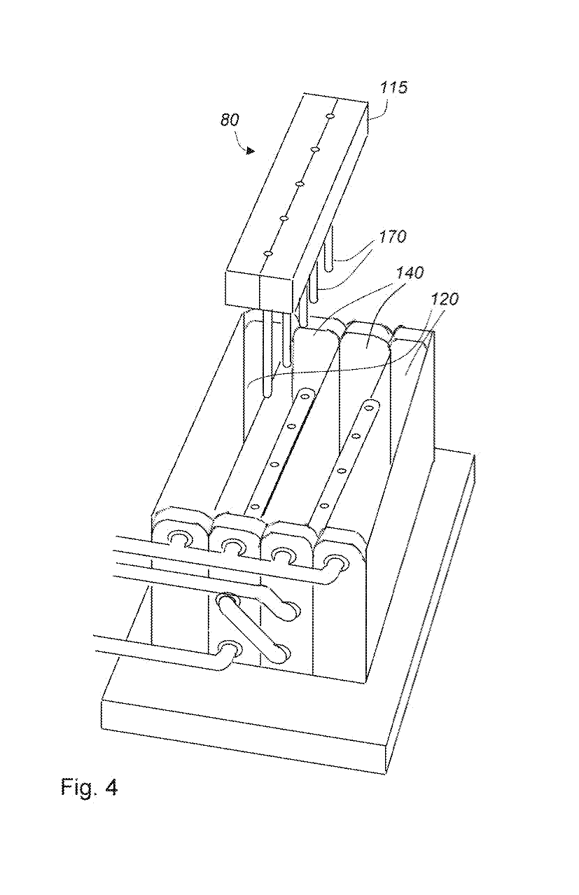

As shown in the figures, the calibrator body 40 is provided with an inlet 44 and an outlet 46 for connection to a circulation system, as further described in connection with FIG. 4. In addition to the fact that the circulation system provides forced through-flow of the medium 43 through the calibrator body 40, it is also provided with means for producing an overpressure, and possibly also an underpressure, in the medium in the calibrator body 40.

The placing of the inlets and outlets shown in the drawings is only meant as illustrating examples. In the embodiments shown they may for example be placed tangentially in order to produce a vortex-like flow in the container. Generally, one will aim at a placing and a structural design that provides an optimal and uniform distribution of the through-flow, thereby obtaining minimal temperature gradients.

In FIGS. 1A and 1B, the apparatus is shown in a state wherein there is no overpressure in the medium 43. The inner wall of the calibrator body 40, i.e. the second membrane 50, then takes a position wherein it forms a suitable opening 60 for introduction of the temperature sensor 70 to be calibrated. When the sensor 70 has been introduced into the opening 60 the medium is subjected to an overpressure so that the second membrane or flexible wall 50 of the calibrator body is brought into tight-fitting abutment against the sensor 70. Thus a complete or approximately complete contact between the calibrator body 40 and the sensor is achieved, wherein the flexible wall adapt itself to the shape of the sensor, to assure an optimum heat transfer and controllable border conditions.

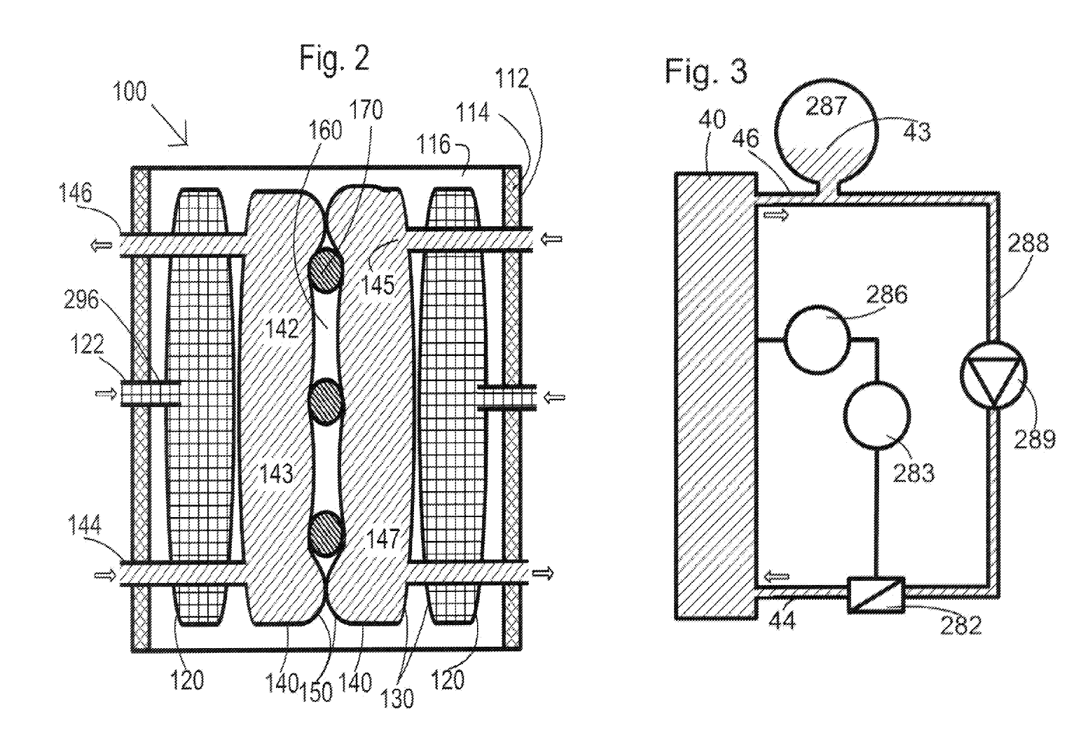

FIG. 2 shows a second embodiment of the apparatus according to the invention. In this embodiment, the cavity-defining jacket 112 forms an upwardly open container having a rectangular cross-section as shown in FIG. 2, and having a cavity 116 in which there are placed two thin walled essentially equal pressure bodies 120. Said pressure bodies defines a cavity in which there are placed two thin-walled, essentially equal calibrator bodies 140 which may be formed from an elastic material, or possibly from a suitably deformable, s pliable, but inelastic material. Each calibrator body 140 defines a volume 142 receiving the relevant heat-transferring medium or calibration fluid 143 (gas or liquid).

Each calibrator body 140 has an outer wall defined by a first membrane 130, and an inner wall defined by a second membrane 150 thus defining a slot-shaped opening 160 extending centrally between a pair of opposite side walls of the container and being adapted for introduction and receipt of two or more sensors to be calibrated, in the illustrated case three sensors 170. One of these sensors possibly may be an extra reference sensor which will thus be subjected to a temperature and a thermal condition which is so similar to the condition of the sensor or sensors to be calibrated that it will constitute a very accurate calibration reference.

At the upper side of the calibrator bodies 140, where the slot 160 debouches and the sensors 170 are to be introduced, there is applied an insulation 115 of an elastic material.

It is noted that for pressure to be transferred from the pressure body 20, 120 to the calibration body 40, 140, it suffices that the outer wall 30, 130 of the calibration body is displaceable, i.e. it need not be a membrane. In some cases the pressure may be applied directly to the calibration body 40, 140, e.g. by an accumulator as discussed below. In these cases, the pressure bodies may be disposed with. In all embodiments, the flexible inner wall 50, 150 is forced into close engagement with the temperature sensors 70, 170 to be calibrated during calibration. In order to remove and insert temperature sensors in the opening 60, 160 the pressure, and hence the force acting on the temperature sensors from the inner wall 30, 130, is reduced.

A separate pressure body is preferred in many applications, because then the pressure can be controlled substantially independent of the temperature of the calibration fluid. Also, the calibration fluid 43, 143 may be a liquid and not subject to temperature changes proportional to the pressure, and the fluid within the pressure bodies may, for example, be a gas.

In a similar manner as in the first embodiment, each calibrator body 140 further is provided with an inlet 144 and an outlet 146 for connection to a circulation system which provides for a forced appropriate through-flow of the medium 143 through the calibrator bodies 140, and for the provision of an overpressure in the medium when this is desired.

hl a preferred embodiment, this circulation system controls the temperature within the calibration body through heating or cooling the calibration fluid in a closed circuit outside the calibration unit, e.g. by means of a Peltier element and/or other heating and/or cooling devices, controlled in response to a sensor (not shown) placed within the calibration fluid.

The calibration body is assumed to be reasonably thermally insulated from the surrounding environment. However, temperature gradients may arise due to imperfect insulation and convection of the calibration fluid against hotter or colder inner surfaces of the calibration body, in particular when there is a large temperature gradient over the insulation between a hot or cold calibration fluid and a surrounding environment at room temperature. The circulation system helps controlling the temperature gradient within the calibration body by adjusting the internal flow of calibration fluid. For this purpose, the circulation system comprises pumps, accumulators and other means which are known to the skilled person. A preferred arrangement of inlet and outlet pipes within the volume 42, 142 containing calibration fluid 43, 143 is discussed below.

In FIG. 2, the apparatus is shown in a first state in which there is zero overpressure in the medium 143. The inner walls 150 of the calibrator bodies 140 then take a position in which the slot 160 is open for introduction of the temperature sensors 170. In a second state in which the medium in the calibrator bodies is subjected to an overpressure, so that the second membrane 150 of the calibrator body is brought into tight-fitting abutment against the sensors 170, the inner walls having adapted themselves to the shape of the sensors.

FIG. 3 shows a calibrator body 40 which is connected to a circulation system comprising a controlling circuit for regulating the temperature of the medium, and possibly also the through-flow velocity thereof through the calibrator body. The controlling circuit is advantageously a closed loop, as this tends to provide an improved control over the relevant parameters.

Thus, the calibrator body 40 has an inlet 44, 144 and an outlet 46, 146 which are connected to a pipeline 288 having a pump 289 for circulation of the medium 43, 143. In the pipeline 288 there is further connected a heat-controlling unit 282, i.e. cooling and heating devices, controlled by a regulating circuit 283. The regulating circuit supplies control signals from a number of temperature sensors 286 placed at appropriate places in the medium flow. The regulating circuit regulates supply or removal of heat energy via the unit 282, and it also controls the speed of the pump 289 and thereby the flow velocity of the medium, thus achieving the desired reference temperature of the medium in the calibrator body 40.

To the calibrator body there is also connected a volume regulating device in the form of an accumulator for heat transferring medium 287 for adjusting the volume of medium 43, and thereby the volume of the calibrator body. This device is shown to be connected to a pump 289 connected to a pipeline 288, the medium in this embodiment of the apparatus being presupposed to be a liquid.

The use of a gas may have advantages in case of extremely high or low temperatures.

The calibrator bodies are preferably internally equipped with a system of manifolds 45, 145, 47, 147 with nozzles for inlet- and outlet fluid flow, to assure a well distributed fluid flow, and hence an equal temperature distribution inside the calibration bodies. Nozzles for inlet, respective outlet, of the fluid should not be positioned directly opposite to each other, to prevent the fluid flow going directly from inlet to outlet, instead of distributing inside the calibrator body. The manifolds should be positioned in such a way that they secure optimal fluid flow and not preventing the thermometers from being enclosed. The manifolds are connected through tubes or pipes to a circulation pump, or a fan for gas.

The inlet manifold should optimally be placed near the bottom of the respective calibration body, and equipped with a number of nozzles to spread the fluid flow optimally. The nozzles should preferably have the main direction upwards and may have some angular spread to distribute the fluid flow. The sum of the cross sections of the inlet nozzles should correspond to cross section of the heat exchanger piping.

The outlet manifold should be optimally placed at the top of the respective calibration body, and preferably provided with a number of outlet nozzles, not corresponding to the positions of the inlet nozzles. Like the inlet nozzles, the outlet nozzles may have some angular spread; however the main direction should be downwards. The sum of the cross sections of the outlet nozzles should be somewhat smaller, about 20%, compared to the inlet nozzles.

To prevent the membrane of the calibrator body clinging to the outlet manifold and thus hindering the circulation around the manifold, it should be provided with comparatively deep threads or grooves. Since the cross sections of the inlet nozzles will normally be larger than for the outlet, so will also the manifolds, hence the vertical positioning of the manifolds will be the optimal for giving the thermometers space.

It is important that the temperature is uniform across all temperature sensors. Since temperature is changing with distance from outlet manifold, it has been found that the use of a counter flow in the two calibrator bodies provides improved uniform temperature along the length of the cavity. The counter flow is e.g. provided by ensuring that the fluid flow in the is first calibrator body flows in the opposite direction from the fluid flow of the second calibrator body. Thus the thermal contact between the two calibrator bodies will even out the temperature distribution.

To the pressure bodies there is also connected a pressurising pump 292 via a pressurising pipeline 296 to the connectors 22, 122.

A number of variations on the above can be envisaged. For instance heat insulating layer 14, 114 can be placed between the calibrator body 40, 140 and the jacket 12, 112 and the bottom of the container.

The first membrane 30, 130 between the pressure body and the calibrating body can either be a single membrane wherein the pressure body and the calibrating body are attached or a compound membrane, wherein the pressure body and the calibrating body can easily be detached from each other.

The second membrane or inner wall 50, 150 can in an alternative embodiment be applied like a sheath over the sensor to be calibrated and then be inserted into the heat transferring medium. Optionally the collar of the sheath can be attached to the calibrating body to enable the heat transferring medium to be put under pressure without spilling said medium.

While the pressure body is typically defined by a separate thin walled body it can alternatively be a volume defined by the calibrator body fitting tightly to the jacket, leaving a volume between the calibrator body and the jacket that can be pressurised.

The pressure bodies will give efficient thermal insulation of the calibration bodies of the sides adjacent. The thermal insulation will be even more efficient if the natural convection in the gas filling is hindered by filling a cell structured spongy material into the pressure bodies. The gas filling will be subject to a pressure increase, or a pressure drop dependent upon the lo temperature, following the State Equation of ideal gases. To compensate for this effect, the simplest solution may be to connect the gas filling of the pressure bodies to a pressure reservoir subject to the temperature of the ambient, or controlling the temperature and hence the pressure.

If the thin walled material of the calibrator bodies is pliable, but not elastic, the calibrator bodies are allowed to change the volume in order to have the thin walled material embracing the thermometers. This is obtained by carrying the manifolds at one end applying a bushing, permitting the manifolds to slide freely in the longitudinal direction. The bushing should have a slot in order not to hindering the fluid flow from, or into the nozzles. It may be feasible also to apply a hydraulic accumulator, to help changing the volume of the fluid inside the calibrator body. In this case, the air filling of the hydraulic accumulator should stay in free contact with the air in the pressure bodies.

A device for holding thermometers in an apparatus for calibration according to the present invention, preferably built of a material giving good thermal insulation, and being easy to machine, comprising two substantially parallel pieces, being hinged together at one end and shaped/adjusted, individually, to hold/clamp the thermometers of different geometry. The device, called a clamp 80, keeping the thermometers, is together with the thermometers to be calibrated and together with the reference thermometer, inserted in the slot above the calibration bodies, and kept in place by the thermal insulation between the inner and the outer calibrator box. Hence the thermometers to be calibrated, together with the reference thermometer, are, usually manually, clamped into a fixed position in the opening and inserted into the slot between the calibrator bodies, before imposing pressure into the pressure bodies.

A flexible foam within the clamp can also retain the temperature sensors and provide the required insulation. The choice of foam or other insulation depends on the calibration temperature. A number of foams and readily formed suitable materials are available for temperatures a few tens of K from room temperature.

In the first state in which there is zero overpressure there is a tendency for the calibrator body 40, 140 to sag, particularly if the calibrator body is filled with a liquid heat transferring medium 43, 143. This problem can be overcome by attaching a member to the calibrator body with stiffness and size sufficient to overcome the sagging due to the heat transferring medium acting under gravity. This part can also be attached to the jacket 12, 112.

In order to avoid such sagging, it is also possible to keep a residue pressure in the pressure bodies. In a preferred embodiment using a liquid calibration fluid and a gas to provide pressure in the pressure bodies, the residual pressure required to avoid sagging is less than or is equal to the pressure at the bottom of a column of calibration liquid extending through the volume 42, 142.

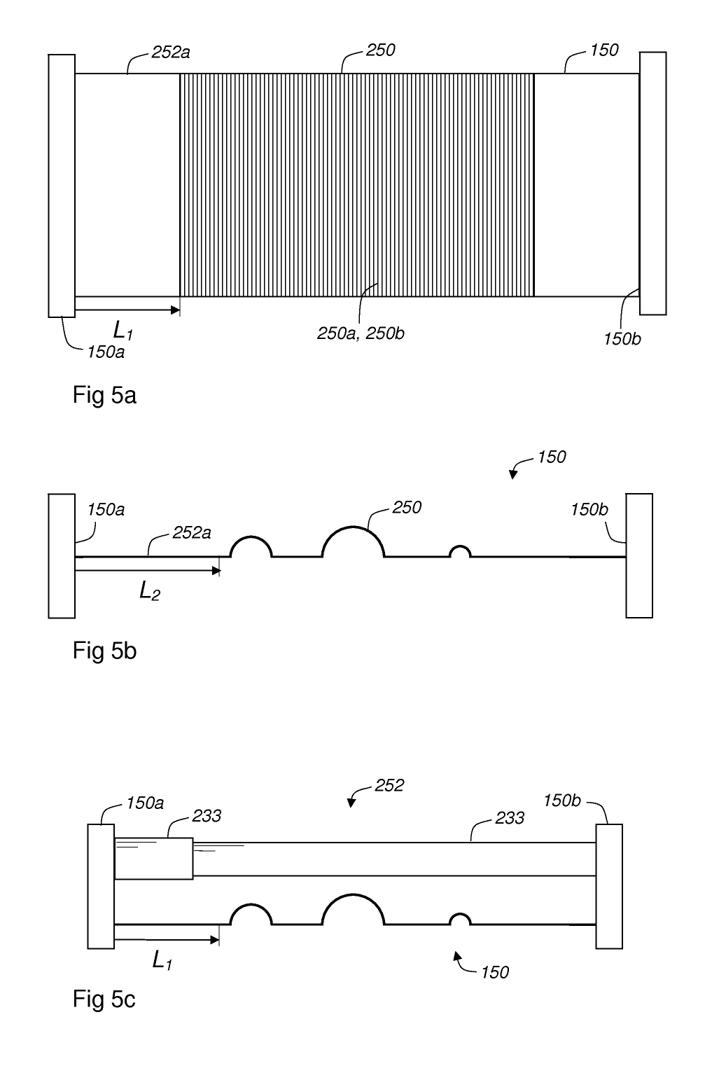

FIG. 5a is a side view of an inner wall 150 of the calibration body, i.e. the flexible wall facing the temperature sensors 170 to be calibrated. As discussed above, the flexible wall should engage the temperature sensors tightly during calibration in order to prevent undesired gaps and uncertain border conditions. For this purpose, the inner wall 150 should be as flexible as possible, even elastic. However, otherwise suitable elastic materials, e.g. a silicone rubber membrane, lack the durability needed for extensive use, especially field use. Such materials are worn, or even torn, by temperature sensors engaging the membrane when they are removed or inserted. To increase durability, it is provided a non-elastic wear resistant region 250 facing the opening 160 (FIG. 2). The wear resistant region 250 can comprise a reinforced sheet, e.g. a fibre reinforced sheet 250a such as a sheet containing fibres of glass, ceramics or carbon. An alternative or addition to such a reinforced sheet 250a is to provide a partial coating 250b on the surface facing the temperature sensors 170 to be calibrated. The coating can, for example, comprise graphene, which can be grown onto a suitable elastic or flexible substrate.

A reinforced sheet 250a and/or a coating 250b in the region 250 should retain the inner wall's ability to fold around the sensors 170. Still, a reinforcement and/or coating tend to decrease the elasticity in the wear resistant region 250. Hence the non-elastic wear region 250 is connected to a path compensator 252.

FIG. 5b is a top view of the inner wall 150. As the flexible wall 150 folds around and engages s temperature sensors 170 of various numbers and sizes, the path from retainer 150a, through the regions 252a and 250 to retainer 150b is extended buy the ‘bumps’ around temperature sensors (not shown). The region 250 does not stretch, or stretch very little, due to the reinforcement and/or coating. An elastic region 252a shown in FIG. 5b is a first example of a path compensator. When the path is extended around the temperature sensors (illustrated by ‘bumps’ in the path), the elastic part 152a extend from L₁ in FIG. 5a to L₂ in FIG. 5b. The distance between the retainers 150a and 150b is equal in FIGS. 5a and b. This may be advantageous in an embodiment where the calibration body is disposed in a frame with a fixed size.

is FIG. 5c illustrates an alternative path compensator 252 where rigid retainers 150a and 150b are joined by a telescopic coupling. In general, a first end of the inner wall 150 is fixed to a first rigid element 233, a second end of the inner wall 150 is fixed to a second rigid element 234, and the first element 233 is displaceable relative to the second element 234 in a longitudinal direction. The elements 233 and 234 are preferably biased by a spring so as to provide a slight tensioning of the inner wall 150. The purpose is to avoid excess folds and creases in the membrane.

The spring forces exerted by the elastic region 252a in FIG. 5b and the spring bias in FIG. 5c should be limited so that the pressure applied behind the wall, i.e. from the upper side of the bumps in FIGS. 5b and 5c, is able to press the inner wall 150 into close contact with the temperature sensors to be calibrated.

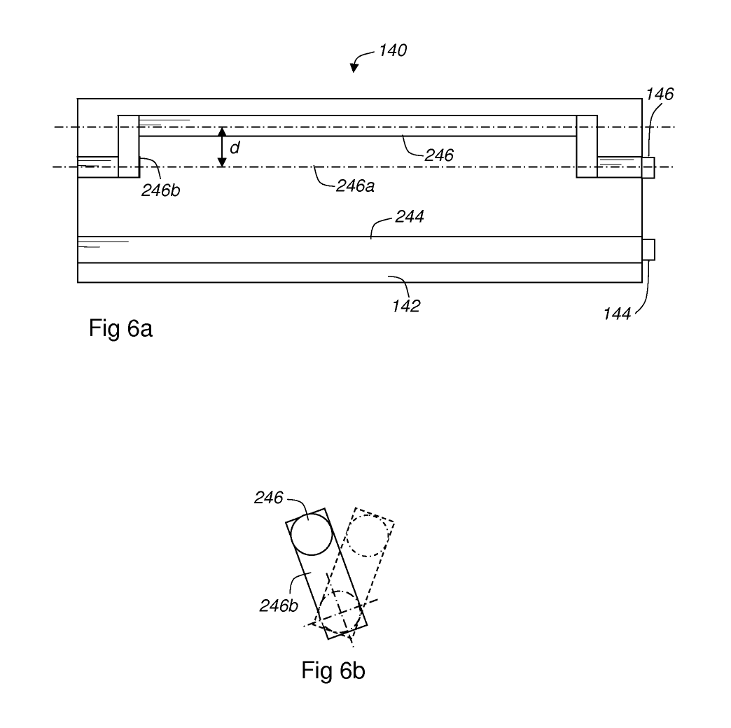

FIG. 6a illustrates a straight inlet pipe 244 extending through an elongated volume 142 within a calibration body 140. The inlet pipe 244 runs near the bottom of the volume, and an outlet pipe 246 connected to the outlet 146 runs similarly near the top of the volume 142. Both pipes 244, 246 have radial holes (not shown) through their walls in order to distribute the volume flow of calibration fluid along their length. The pipes 244 and 246 may be rotatable about their longitudinal axes, e.g. in order to adjust a flow from a row of openings or nozzles to compensate for convection. The positions near the top and bottom also helps reducing undesired convection. The inlet and outlet pipes are preferably thermally conductive to avoid unwanted temperature gradients in the volume 142 containing calibration fluid.

In FIG. 6a, the central axis of the outlet pipe 246 is displaced a distance d from a parallel longitudinal axis 246a through the outlet 146. FIG. 6b is an end view of the outlet axis in FIG. 6a, and illustrates that the outlet pipe 246 can be rotated or pivoted about the outlet axis 246a. This embodiment gives an extra degree of freedom to the placement of the nozzles through the pipe walls, which can be useful for fine tuning the anti-convection and unwanted temperature gradients discussed above. Pivoting about and eccentric axis can also help adapting the calibration body to the viscosity of various calibration fluid. Obviously, the inlet pipe 244 may be arranged in a similar manner independently of the outlet pipe 246.

1. Calibration body for calibration of at least one temperature sensor, the calibration body comprising a volume capable of containing a calibration fluid with a predetermined temperature, an opening for receiving the temperature sensor extending from a first surface of the calibration body into the volume of the body, the opening having a flexible inner wall delimiting the sensor from the volume and capable of tightly engaging the sensor, characterised in that the inner wall comprises a non-elastic wear resistant region facing the opening, and that the non-elastic wear region is connected to a path compensator capable of adjusting a length of the inner wall with an amount corresponding to the path around the temperature sensor in the non-elastic region.

2. Calibration body according to claim 1, wherein the non-elastic region comprises a reinforced sheet material.

3. Calibration body according to claim 1, wherein the non-elastic region comprises a wear resistant coating.

4. Calibration body according to claim 1, wherein the opening is an elongated slot extending in a longitudinal direction of the calibration body.

5. Calibration body according to claim 4, wherein an end of the inner wall is fixed relative to the calibration body and the path compensator is an elastic part of the inner wall between the fixed end and the non-elastic region.

6. Calibration body according to claim 4, wherein a first end of the inner wall is fixed to a first rigid element, a second end of the inner wall is fixed to a second rigid element, the first element being displaceable relative to the second element in the longitudinal direction.

7. Calibration body according to claim 1, further comprising an inlet capable of receiving a flow of calibration fluid from a temperature controlling circuit and an outlet capable of returning the flow to the temperature controlling circuit.

8. Calibration body according to claim 7, wherein the inlet is connected to an inlet pipe extending within the volume of the calibration body.

9. Calibration body according to claim 7, wherein the outlet is connected to an outlet pipe extending within the volume of the calibration body.

10. Calibration body according to claim 8, wherein the inlet pipe has a longitudinal axis displaced from and parallel to a longitudinal inlet axis running through the inlet, and the inlet pipe being rotatable about the inlet axis.

11. Calibration body according to claim 9, wherein the outlet pipe has a longitudinal axis displaced from and parallel to a longitudinal outlet axis running through the outlet, and the outlet pipe being rotatable about the outlet axis.

12. Calibration body according to claim 9, wherein the outlet pipe is displaced relative to the outlet in a direction perpendicular to the longitudinal direction and rotatable about a longitudinal axis running through the outlet.

13. Apparatus for calibration of at least one temperature sensor, the apparatus comprising the calibration body according to any preceding claim, wherein the calibration body further comprises a displaceable outer wall, and a pressure body capable of exerting a pressure on the displaceable outer wall.

14. Apparatus according to claim 12, wherein the calibration body is adapted to fit into a fixed space defined by the pressure body.

15. Apparatus according to claim 12, further comprising a retaining clamp capable of receiving the set of temperature sensors and being adapted to fit into a recess with fixed dimensions over the opening of the calibration body.

16. Apparatus according to claims 12, wherein the pressure body during operation maintains a residual pressure equal to or larger than the pressure at the bottom of a column of calibration fluid through the calibration body.
